(19) United States
(12) Patent Application Publication
(10) Pub. No.: US 2012/0096976 A1
(43) Pub. Date: Apr. 26, 2012

(54) COMPACT PEDAL SYSTEM FOR A MOTOR VEHICLE

(75) Inventors: Carmelo Leone, Freising (DE); Frank Drews, Rothenbach (DE); Jürgen Bäumler, Furth (DE); Thomas Brandt, Edelsfeld (DE)

(73) Assignee: CONTI TEMIC MICROELECTRONIC GMBH, Nürnberg (DE)

(21) Appl. No.: 13/319,619

(22) PCT Filed: May 5, 2010
(86) PCT No.: PCT/EP2010/056064

§ 371 Date: Dec. 16, 2011

(30) Foreign Application Priority Data
May 15, 2009 (DE) 10 2009 021 585.9

(51) Int. Cl. G05G 1/44

(52) U.S. Cl. 74/513

(57) ABSTRACT

A pedal system that has a force resetting device essentially including a pedal lever with a pedal return spring that can bring the pedal lever into the neutral position (PN), an electric motor that can be swiveled about a pivot (M) and can, in the energized state, apply a resetting force (F) to the pedal lever in the direction of the neutral position (PN) of the pedal lever, a motor return spring for resetting the electric motor in the direction of the neutral position (MN) of the electric motor, and a control unit for controlling the electric motor. The electric motor includes a rotor and a stator which is arranged on the shaft of the electric motor, between the rotor and the drive disk.

### CROSS REFERENCE TO RELATED APPLICATIONS

This application is the U.S. National Stage Application of PCT/EP2010/056064, filed May 5, 2010, which claims priority to German Patent Application 10 2009 021 585.9, filed May 15, 2009, the contents of such applications being incorporated by reference herein.

### FIELD OF THE INVENTION

The invention relates to a compact pedal system for a motor vehicle according to a compact pedal system for regulating the speed in a motor vehicle, having a force resetting device which is integrated in a housing.

### BACKGROUND OF THE INVENTION

In the automobile industry there is a trend for the driver of a vehicle to be assisted with respect to driving safety, driving comfort and driving efficiency. Examples of this are lane keeping systems or systems with a cruise controller function. In this context, the driving behavior of the motor vehicle is influenced in an assisting fashion on the basis of measured vehicle parameters and ambient parameters. The forces which have to be applied for this purpose are largely provided by electromechanical systems such as electromotors.

For example, during the influencing of speed, what are referred to as force feedback systems function, in particular simultaneously, as a speed controller, or a speed limiter, and function as a warning device when a predefined speed value is exceeded. In this context, an additional resetting force opposes the force which is applied to the accelerator pedal by the driver's foot for the purpose of increasing the speed. The magnitude of the additional resetting force can depend on the magnitude of the deviation from the speed setpoint value.

Such a device is known from EP 0 617 674 B1, which is incorporated by reference. The device for controlling the power of motors, in particular of motor vehicle motors, comprises a servomotor for regulating the force, in order to apply a controlled resetting force via a mechanical connection to the power regulating element which is activated directly by the driver, for example an accelerator pedal. This force which is transmitted by a mechanical connection is generated by a spring which is assigned to a three-point mechanism in which a motor moves the force components which act on the output element of the servomotor.

Such a device for controlling the speed of a vehicle is composed of a multiplicity of independent components which have to be mounted and adjusted to one another with great effort. The resetting force acting on the pedal is generated by applying a complicated deflection mechanism. As a result, both the manufacture and the calibration of the device are very costly.

DE 10 2004 025 829 B4, which is incorporated by reference, discloses a force feedback device, wherein the resetting force is generated by means of a torque motor composed of a stator and a rotor. The rotor is of disk-shaped configuration and is coupled to the pedal lever by means of a plunger element which is arranged eccentrically on the rotor, in such a way that the plunger element only bears against the pedal lever and can apply a resetting force thereto only counter to the direction of activation of the pedal lever when the rotor rotates.

A disadvantage of this device is that, when the resetting force is applied to the pedal lever by the rotor, a relatively large bending torque acts directly on the rotor shaft. As a result, as a rule the air gap between the stator and rotor changes and the actuation capability of the torque motor is adversely affected.

### SUMMARY OF THE INVENTION

An aspect of the present invention is therefore to make available a simple, compact and, in particular, robust pedal system comprising few components, for use in a motor vehicle in such a way that both the costs for material and the manufacture as well as the required installation space are low, and a high level of functional reliability is ensured.

This is achieved according to aspects of the invention by means of thea compact pedal system for regulating the speed in a motor vehicle, having a force resetting device which is integrated in a housing, comprising a pedal lever for converting the driver's request to speed, wherein the pedal lever can be pivoted about a center of rotation (P) from a zero position (PN) of the pedal lever to an end position (PE) of the pedal lever, a pedal return spring which can move the pedal lever to its zero position (PN), an electric motor, which can be pivoted about a center of rotation (M) from a zero position (MN) of the electric motor to an end position (ME) of the electric motor, and which in the energized state can apply a resetting force F to the pedal lever in the direction of the zero position (PN) thereof, wherein the respective rotational direction from the end position (PE, ME) to the zero position (PN, MN) is identical for the pedal lever and the electric motor, a drive pulley which is connected to the electric motor by means of a shaft which applies the resetting force to the pedal lever by means of a drive roller which is arranged eccentrically on the drive pulley, wherein, when the resetting force (F) is applied to the pedal lever, the drive roller merely bears on the pedal lever, a motor return spring for resetting the electric motor in the direction of the zero position (MN) of the electric motor, a control unit for controlling the electric motor, wherein the electric motor comprises a rotor and a stator, wherein the stator is arranged on the shaft of the electric motor between the rotor and the drive pulley.

The invention describes a compact pedal system for use in a motor vehicle having a housing and having a force resetting device which is integrated in the housing. The additional resetting force on the pedal lever in the direction of the zero position thereof is generated, in particular, by energizing an electric motor. The electric motor comprises a stator and a rotor which is arranged on a shaft. In addition, a drive pulley, which can apply the resetting force to the pedal lever by means of a drive roller which is arranged eccentrically on the drive pulley, is arranged on the shaft of the electric motor. In particular, the stator is arranged on the shaft of the electric motor between the rotor and the drive pulley. This has the advantage that the effect of the bending torque on the rotor which is small when the resetting force on the pedal lever is applied to the shaft by the drive pulley since the rotor is arranged on the side of the stator lying opposite the drive pulley. Owing to this arrangement, the air gap between the stator and the rotor is not changed and the actuation capability of the electric motor is not adversely affected.

As a result of the fact that the radial bearing, by means of which the shaft is mounted in the stator, extends very largely over the entire length of the stator, relatively large radial forces which act on the electric motor via the shaft when a resetting force is applied to the pedal lever can be compensated. The radial bearing is configured, for example, as a plastic sliding bearing and is pressed into the stator.

In order to convert the driver's request into speed, the pedal lever can be pivoted about a center of rotation, specifically from the zero position of the pedal lever, which means that the rotation speed of the vehicle motor is the idling rotational speed, up to an end position of the pedal lever, which signifies a fully open throttle. A pedal return spring is arranged on the pedal lever in such a way that the pedal lever is pressed into its zero position, that is to say the vehicle engine is forced to rotate with the idling rotational speed when the driver of the vehicle takes his foot off the pedal lever. The electric motor can be pivoted about a center of rotation from a zero position of the electric motor to an end position of the electric motor. The center of rotation of the pedal lever and the center of rotation of the electric motor can also be identical. A motor return spring is arranged at the electric motor in such a way that the drive pulley of the electric motor also presses the pedal lever in the direction of the zero position thereof via the drive roller, in particular when the electric motor is not energized. The pedal return spring and the motor return spring can either be embodied in a linear fashion, for example as a helical spring, or in a rotational fashion as a torsion spring or leg spring. In this context, in each case one end of the spring is generally permanently connected to the housing. The other end of the spring acts on the pedal lever or on the drive pulley. The fact that the angular range which is determined by the respective zero position and end position of the spring is larger in the case of the motor return spring, both in the zero position and in the end position, than in the case of the pedal return spring, ensures that the drive pulley bears against the pedal lever via the drive roller at all times, that is to say the drive pulley is always prestressed, at least in the de-energized state of the electric motor. For the actuation of the electric motor, in particular by a control element which is integrated into the pedal system, it is advantageous to sense the respective angular position both of the pedal lever and of the electric motor by means of a corresponding sensor in each case.

The hysteresis element of the pedal system is preferably formed by a sliding bushing at the center of rotation of the pedal lever. The function of the sliding bushing can also be implemented, in particular, by a suitable material pairing of the materials of the pedal lever and of the shaft on which the pedal lever is arranged. These material pairings can be proud over the entire circumference of the defined frictional faces, for example can each be arranged over 120°. These proud faces can be provided both on the pedal lever and on the housing.

In certain cases it may be necessary for the driver of the vehicle to override the entire resetting force which the pedal lever experiences as a result of an energization of the electric motor, in particular in hazardous situations such as an excessively small distance from the vehicle travelling ahead, in order, for example, to initiately an overtaking process. For this purpose, the pedal system can have an overload clutch. This overload clutch is preferably arranged as a slip clutch between the drive pulley and the rotor. In this context, for example an axial force is applied, for example, via a spring package in the slipping clutch, which axial force is larger in the normal state than the actuation force of the foot of the driver of the vehicle on the pedal lever. In order to be able to overcome the force, the friction clutch is arranged in a freely rotatable fashion on the shaft of the electric motor. As a rule, the electric motor itself can also be overridden without suffering damage.

In the event of the electric motor blocking due to a defect, for example as a result of overheating, an emergency means, which permits the resetting force on the pedal lever to be overcome by the driver of the vehicle when the electric motor blocks, can be arranged in the pedal system, on the electric motor. Such an emergency means may be implemented, for example, by toothing on the drive pulley and corresponding toothing on the outer face of the shaft of the electric motor which engages in this toothing and is in the region of the drive pulley. In the normal state, the transmission of force from the electric motor to the pedal lever takes place via these toothings which engage one in the other. In an emergency, this toothing is destroyed by the overriding process and the resetting force on the pedal lever is cancelled out by the electric motor. Such an emergency means can be used, in particular, in pedal systems in which an overload clutch has to be dispensed with for reasons of space.

At low external temperatures, the friction losses in the electric motor and also in the pedal lever may be increased compared to normal temperatures. In order to avoid such an increase in the friction, the electric motor can be briefly energized at certain time intervals, wherein the time intervals may be predefined randomly or by the control unit. If in an emergency situation, for example in the event of a traffic accident, the foot of the driver of the vehicle loses contact with the pedal lever during travel with a fully opened throttle, it is necessary, for safety reasons, to ensure that the pedal lever is moved to its zero position within a prescribed time, in order to quickly reduce the rotational speed of the motor to the idling rotational speed. In the normal case, both the pedal return spring and the motor return spring press the pedal lever into its zero position quickly enough. In certain embodiments of the pedal lever, the motor return spring is a relatively weak configuration in order, in particular, to achieve a large variety of pedal characteristic curves. In the event of a malfunction of the pedal return spring, for example due to breakage, the motor return spring alone could be too weak to move the pedal lever to the zero position in the prescribed time. In such cases, it is necessary to monitor the function of the pedal lever return spring by means of a separate monitoring element. This could be easily implemented, for example, by means of a mechanical pressure switch on which in the normal case one end of the pedal lever return spring continuously applies a pressure. If the pedal lever return spring fractures, the pressure switch triggers a corresponding warning signal to the driver of the vehicle or a signal to the control unit in order to apply the necessary additional resetting force to the pedal lever via the electric motor.

For the sake of simplicity, the motor return spring can be configured as a leg spring which is arranged between the stator and the drive pulley. The centers of rotation of the leg spring and of the drive pulley can lie in the axis of the shaft of the electric motor. In this context, the one leg of the leg spring is preferably permanently connected to the housing or coupled to the housing and the other leg presses against the drive pulley.

A brushless direct current motor can be used, for example, as an electric motor. In order to be able to use a direct current motor with a small overall size and low power drain, a self-locking transmission is generally additionally used to increase the force, which has the advantage that after a predefined resetting force has been reached by the direct current motor, the latter can be placed in a de-energized state, and the resetting force is maintained by the self-locking effect of the transmission. The self-locking transmission is then advantageously arranged between the drive pulley and the rotor and is permanently connected to the shaft of the electric motor in order to transmit force. In this case, the drive pulley is mounted in a freely rotatable fashion on the shaft of the electric motor. The one end of the motor return spring acts on the drive pulley, and the other end of the motor return spring is permanently connected to the self-locking transmission. As a result, the prestress of the motor return spring can be varied, both in the direction of the zero position and in the direction of the end position of the electric motor, between a minimum value and a maximum value.

### BRIEF DESCRIPTION OF THE DRAWINGS

The invention is best understood from the following detailed description when read in connection with the accompanying drawings. Included in the drawings is the following figures:

FIG. 1 shows a pedal lever system with a pedal lever, electric motor and control unit,

FIG. 2 shows an arrangement of a stator and rotor according to the prior art,

FIG. 3 shows an arrangement of a stator and rotor according to aspects of the invention,

FIG. 4 shows a pedal lever system with a pedal lever in its zero position,

FIG. 5 shows a pedal lever system with a pedal lever in its end position,

FIG. 6 shows a three-dimensional view of the pedal lever system, and

FIG. 7 shows a pedal lever system, wherein the region of the pedal return spring and part of the region of the rotor can be seen in the detail.

### DETAILED DESCRIPTION OF THE PREFERRED EMBODIMENTS

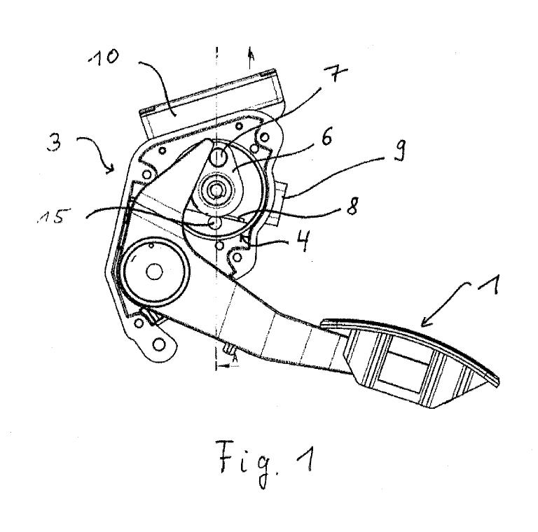

FIG. 1 shows a compact pedal system for regulating the speed, wherein a force resetting device is integrated into the housing 3. The pedal system comprises essentially a pedal lever 1 for converting the driver's request into speed. An electric motor 4, in particular a torque motor, as a further component of the force resetting device can, in the de-energized state, apply a resetting force to the pedal lever 1 in the direction of reducing the speed. At the electric motor 4, a drive pulley 6 is rotatably arranged, which drive pulley 6 can apply the resetting force to the pedal lever 1 by means of a drive roller 7 or other suitable devices such as, for example, sliding free-form faces. A control unit 10 for controlling the electric motor 4 is also integrated into the housing 3.

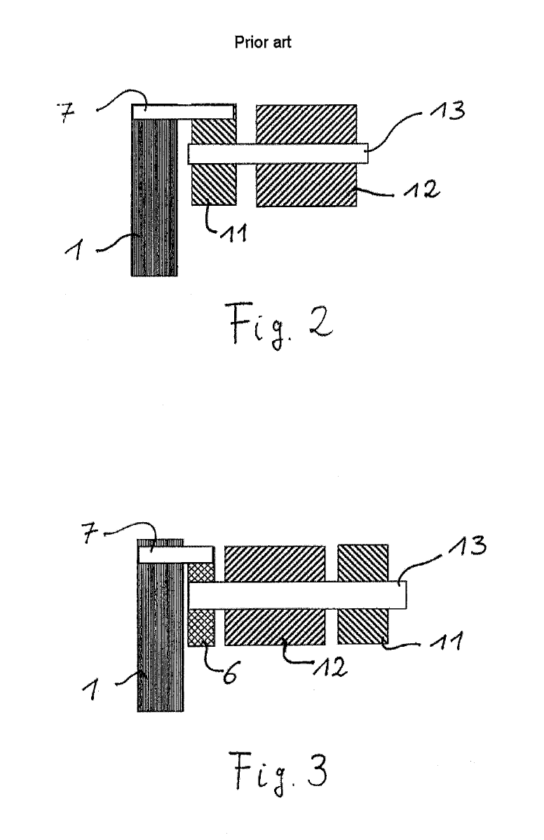

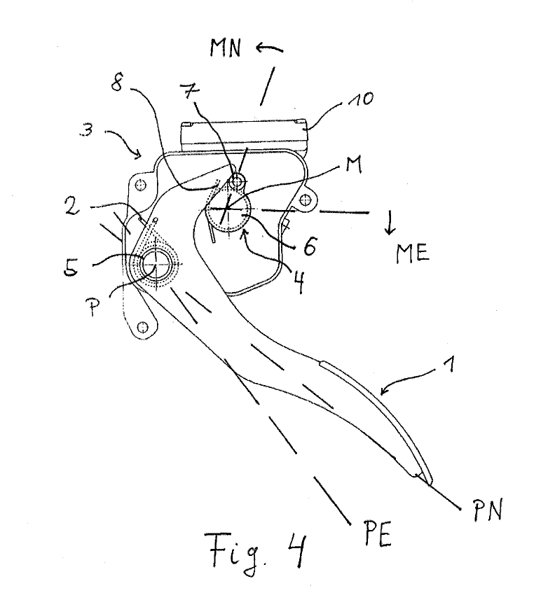

The electric motor 4 comprises essentially a stator 12 and a rotor 11 which is connected to a shaft 13 which can rotate in the stator 12. FIGS. 2 and 3 each show a basic arrangement of the components of the electric motor 4. FIG. 2 shows an electric motor 4 according to DE 10 2004 025 829 B4. The drive roller 7, which applies the resetting force to the pedal lever 1 when the electric motor 4 is energized, is mounted directly on the rotor 11. The force which acts on the pedal lever 1 results in turn in a torque which acts as a bending torque on the shaft 13, in the direction perpendicular to the axis of the shaft 13. As a result, changes in the air gap between the rotor 11 and the stator 12 may occur and can adversely affect the actuation capability of the electric motor 4.

FIG. 3 shows the arrangement of the components of the electric motor 4 according to aspects of the invention. The stator 12 is arranged on the shaft 13 between the rotor 11 and the drive pulley 6. The drive roller 7, which applies the resetting force to the pedal lever 1 when the electric motor 4 is energized, is arranged here on the drive pulley 6, for example screwed or pressed in. The influence of the bending torque on the air gap between the rotor 11 and the stator 12, which bending torque acts on the shaft 13 of the electric motor 4 when the resetting force is applied, is generally significantly smaller in this case than in the arrangement shown in FIG. 2. The functional capability of the electric motor 4 is accordingly ensured even in the case of relatively high resetting forces in this arrangement.

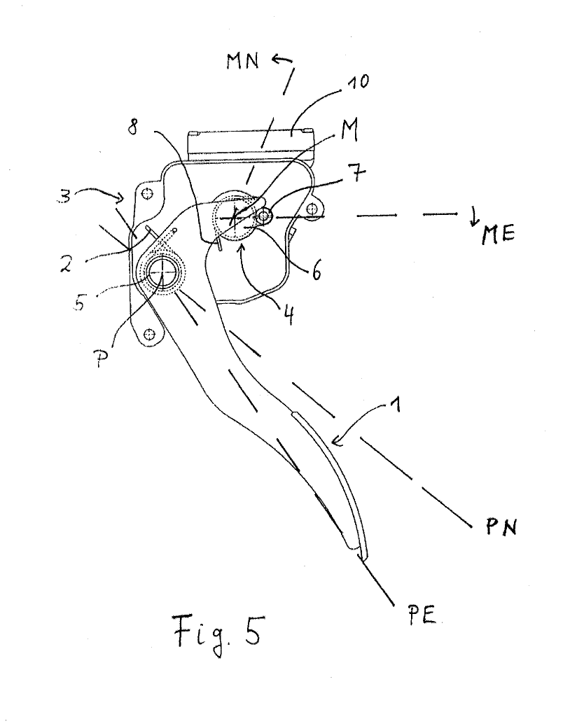

FIG. 4 shows a pedal system with a pedal lever 1 in its zero position PN. This means that the foot of the driver of the vehicle on the pedal lever 1 does not apply any force in the direction of increasing the speed and the motor of the vehicle rotates with the idling rotational speed. The pedal lever 1 can be pivoted about the center of rotation P, specifically from a zero position PN to the end position PE, which means, when translated into the rotational speed of the motor, from idling to a fully open throttle. In this case, a leg spring is arranged as a pedal return spring 2 at the center of rotation P of the pedal lever 1 in such a way that said leg spring presses the pedal lever 1 into its zero position PN. As an alternative, a linearly acting spring would also be conceivable as a pedal lever return spring 2, in particular outside the center of rotation P. The electric motor 4 can be pivoted about its center of rotation M, specifically from its end position ME to its zero position MN. In the case described, the centers P and M of rotation of the pedal lever 1 and of the electric motor 4 are positionally separated. However, a pedal system in which the two centers P and M of rotation coincide would also be perfectly possible.

A motor return spring 8 is arranged at the electric motor 4 in such a way that the drive pulley 6 of the electric motor 4 also presses, by means of the drive roller 7, the pedal lever 1 in the direction of the zero position PN thereof, in particular when the electric motor 4 is not energized. In this context, here, one end of the pedal return spring 2 or motor return spring 8 is permanently connected in each case to the housing 3, at least in the pressing direction of the spring. Here, the one end of the motor return spring 8 is coupled to the pin 15 of the housing 3. The other end of the pedal return spring 2 acts on the pedal lever 1 and/or that of the motor return spring 8 acts on the drive pulley. The angular range, which is determined by the respective zero positions NM, PN and end positions ME, PE of the springs 2, 8, is larger in the case of the motor return spring 8 both with respect to the zero position MN and with respect to the end position ME than in the case of the pedal return spring 2. This is also respectively indicated in FIG. 4 and FIG. 5 by arrows in the directions MN and ME. This ensures that the drive pulley 6 bears against the pedal lever 1 at all times via the drive roller 7. This means that the motor return spring 8 is always prestressed, at least in the de-energized state of the electric motor 4.

For the actuation of the electric motor 4, in particular by a control unit 10 which is integrated into the pedal system, it is advantageous for the respective angular position both of the pedal lever 1 and of the electric motor 4 to be respectively sensed by a corresponding sensor, for example a Hall sensor. Corresponding sensors are, however, not shown in the figures.

FIG. 5 corresponds to FIG. 4, with the one difference that the pedal lever 1 is in its end position PE. The end position ME of the electromotor 4 is, however, not yet reached, which is indicated in turn by the arrow in the direction ME. This means that by correspondingly energizing the electric motor 4 it would be possible to move the electric motor 4 further in the direction of its end position and therefore lift it off from the pedal lever 1.

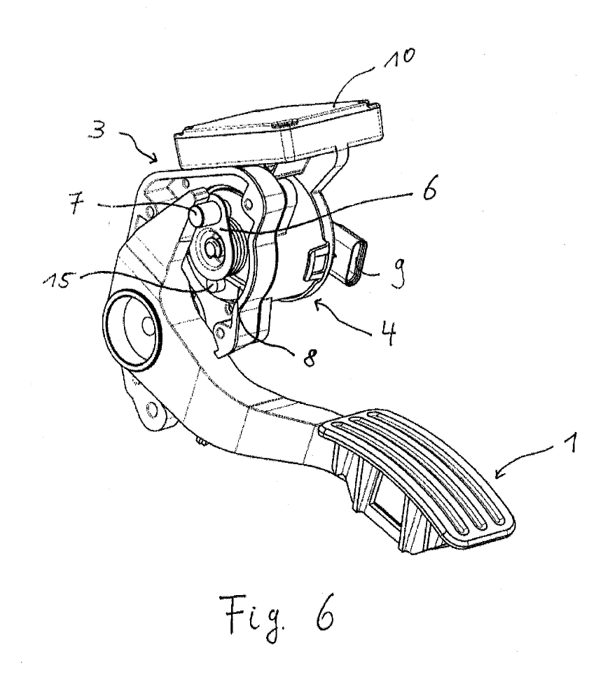

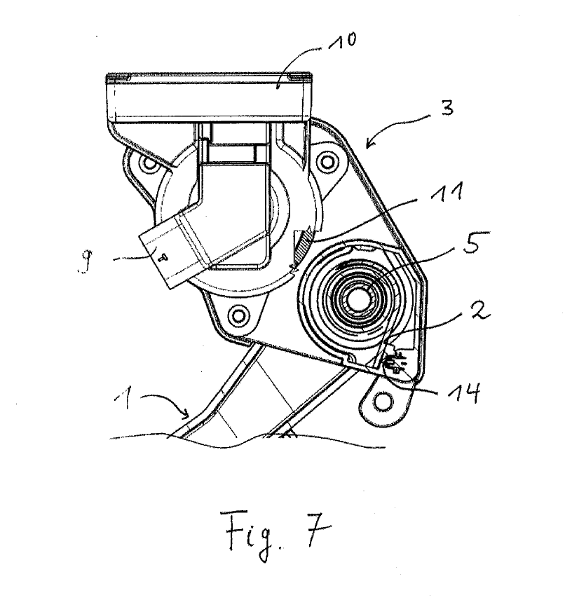

FIG. 6 shows a pedal system in a three-dimensional view. For example a brushless direct current motor with self-locking transmission is used as the electric motor 4 here. The self-locking transmission is arranged between the drive pulley 6 and the rotor 11 in a way which is not shown, and is permanently connected to the shaft 13. In this case, the drive pulley 6 is arranged in a freely rotatable fashion on the shaft 13. The one end of the motor return spring 8 acts on the drive pulley 6. The self-locking transmission applies the resetting force to the other end of the motor return spring 8 by means of the pin 15. As a result, the prestressing of the motor return spring 8 can be varied, both in the direction of the zero position MN and in the direction of the end position ME of the electric motor 4, between a minimum value and a maximum value.

The interface 9 comprises the power supply of the power electronics and therefore that of the electric motor 4 and the exchange of signals between the control unit and the periphery outside the pedal system via a CAN bus. For safety reasons, a second interface (not shown) is reserved exclusively for transmitting the signals of the sensor for the angular position of the pedal lever 1.

FIG. 7 shows the pedal system from FIG. 6 from the side lying opposite the pedal lever 1, wherein specifically the region of the pedal return spring 2 and a partial region of the rotor 11 can be seen in the detail. The one end of the pedal return spring 2 presses on the monitoring element 14 which is embodied as a compression spring. The circuit in the pressure switch 14 may be open or closed. When the pedal return spring 2 fails, for example due to breakage of the spring, the pressure switch 14 triggers a signal which can warn the driver of the vehicle and/or can emit a signal to the control unit 10 in order to apply an additional resetting force via the electric motor 4 and as a result correspondingly prestress the motor return spring 8.

This ensures that, in an emergency situation, for example in the event of a traffic accident when the foot of the driver of the vehicle loses contact with the pedal lever, in particular in the case of travel with a fully open throttle, the pedal lever 1 is moved into its zero position PN within a prescribed time, in order to quickly reduce the rotational speed of the motor to the idling rotational speed. Both the pedal return spring 2 and the motor return spring 8 usually press the pedal lever 1 back to its zero position quickly enough. However, in certain embodiments of the pedal system, the motor return spring 8 is a relatively weak configuration in order, for example, to be able to implement a large variety of pedal characteristic curves. In the event of a malfunction of the pedal return spring 2, for example due to breakage, the motor return spring 8 could be too weak to independently move the pedal lever 1 into the zero position PN in the prescribed time.

### LIST OF REFERENCE SYMBOLS

1 Pedal lever
2 Pedal return spring
3 Housing
4 Electric motor
5 Sliding bearing
6 Drive pulley
7 Drive roller
8 Motor return spring
9 Interface
10 Control unit
11 Rotor
12 Stator
13 Shaft of the electric motor
14 Monitoring element
15 Pin
M Center of rotation of the electric motor
MN Zero position of the electric motor
ME End position of the electric motor
P Center of rotation of the pedal lever
PN Zero position of the pedal lever
PE End position of the pedal lever

1.-13. (canceled)

14. A compact pedal system for regulating the speed in a motor vehicle, having a force resetting device which is integrated in a housing, comprising:
a pedal lever for converting the driver's request to speed, wherein the pedal lever can be pivoted about a center of rotation (P) from a zero position (PN) of the pedal lever to an end position (PE) of the pedal lever;
a pedal return spring which can move the pedal lever to its zero position (PN);
an electric motor, which can be pivoted about a center of rotation (M) from a zero position (MN) of the electric motor to an end position (ME) of the electric motor, and which in the energized state the electric motor can apply a resetting force F to the pedal lever in the direction of the zero position (PN) thereof, wherein the respective rotational direction from the end position (PE, ME) to the zero position (PN, MN) is identical for the pedal lever and the electric motor;
a drive pulley which is connected to the electric motor by a shaft which applies the resetting force to the pedal lever by a drive roller which is arranged eccentrically on the drive pulley, wherein, when the resetting force (F) is applied to the pedal lever, the drive roller merely bears on the pedal lever; and
a motor return spring for resetting the electric motor in the direction of the zero position (MN) of the electric motor;
a control unit for controlling the electric motor,
wherein the electric motor comprises a rotor and a stator, wherein the stator is arranged on the shaft of the electric motor between the rotor and the drive pulley.

15. The compact pedal system as claimed in claim 14, wherein the shaft is mounted in the stator by a radial bearing, wherein the radial bearing extends very largely over the entire length of the stator in order to be able to absorb radial forces which are as large as possible and which are caused by the shaft when the resetting force is applied to the pedal lever.

16. The compact pedal system as claimed in claim 14, wherein when the electric motor is de-energized, the pedal return spring and the motor return spring press the pedal lever in the direction of its zero position (PN).

17. The compact pedal system as claimed in claim 14, wherein a sliding bushing is arranged as a hysteresis element at the center of rotation (P) of the pedal lever.

18. The compact pedal system as claimed in claim 14, wherein an overload clutch, by which the resetting force can be overridden by the driver of the vehicle, is arranged at the electric motor.

19. The compact pedal system as claimed in claim 14, wherein an emergency means, by which the resetting force can be overcome by the driver of the vehicle in the event of blocking of the electric motor, is arranged on the electric motor.

20. The compact pedal system as claimed in claim 14, wherein at low external temperatures, the electric motor can be briefly energized at time intervals which are predefined by the control unit or are random, as a result of which the friction losses in the electric motor and in the pedal lever, which are increased by the low external temperatures, can be compensated.

21. The compact pedal system as claimed in claim 14, wherein the center of rotation (P) of the pedal lever and the center of rotation (M) of the electric motor are identical.

22. The compact pedal system as claimed in claim 14, wherein an angular position of the pedal lever can be sensed by a pedal sensor on the pedal lever and an angular position of the electric motor can be sensed by a motor sensor at the electric motor.

23. The compact pedal system as claimed in claim 14, wherein a monitoring element, by which the function of the pedal return spring can be monitored, is arranged on the pedal return spring.

24. Compact pedal system according to claim 14, wherein the motor return spring is configured as a leg spring and is arranged between the drive pulley and the stator.

25. The compact pedal system as claimed in claim 14, wherein the electric motor is configured as a brushless direct current motor with a self-locking transmission, wherein the self-locking transmission is arranged between the rotor and the drive pulley.

26. The compact pedal system as claimed in claim 25, wherein the drive pulley is rotatably mounted on the shaft, and the drive pulley is connected to the self-locking transmission of the electric motor by the motor return spring.
